(19) United States
(12) Patent Application Publication
(10) Pub. No.: US 2019/0250097 A1
(43) Pub. Date: Aug. 15, 2019

(54) DEVICE FOR GAS DETECTION AND QUANTIFICATION

(71) Applicant: VIRA GAS IMAGING, S.L., COMENAR VIEJO (MADRID) (ES)

(72) Inventors: Jose Luis ESTEBAN GARCIA, COLMENAR VIEJO (MADRID) (ES); Jesus Manuel GIL JIMENEZ, COLMENAR VIEJO (MADRID) (ES)

(21) Appl. No.: 15/536,538

(22) PCT Filed: Oct. 28, 2016
(86) PCT No.: PCT/ES2016/070769

§ 371 Date: Jun. 15, 2017

(51) Int. Cl. G01N 21/3504; G01M 3/38; G01M 3/04

(52) U.S. Cl. CPC G01N 21/3504; G01M 3/04; G01M 3/38

(57) ABSTRACT

The device is materialized in an instrument for the detection of emissions of natural gas and other hydrocarbons in gas phase, comprising the combination of a ruggedized tablet (1) and an infrared camera (2), connected together with capacity to be detached, and continue working separately by means of an extension cable, the tablet (1) being provided with a protective casing which determines an ergonomic support (3), with handling grips (5) and a handle (6), also including adjustable straps (4) to hang from the shoulder. The infrared camera (2) includes an interchangeable lens (7), and an electronic board (9) wherein a detector spectrally optimized for hydrocarbon detection is integrated. The design based on a tablet, allows the software to be expanded and modified in the future.

### OBJECT OF THE INVENTION

The present invention relates to a device for gas detection and quantification, specifically leaks of natural gas and other hydrocarbons in gas phase, specifically adapted to the gas and oil industry.

The object of the invention is to provide an “all-in-one” type device for hydrocarbon gas detection, based on infrared technology and specifically adapted for the gas and oil industry.

### BACKGROUND OF THE INVENTION

Although numerous and varied systems and devices are known for gas detection in general, the current market demands this to be performed with infrared technology cameras.

Current general-purpose cameras on the market have a structural and functional complexity, as well as a high manufacturing and, hence, acquisition cost.

### DESCRIPTION OF THE INVENTION

The system claimed, determining an “all-in-one” apparatus, is formed from a ruggedized tablet on which an infrared camera is detachably coupled and wherein the tablet has a ruggedness level that allows withstanding hard falls and gusts of rain, wind, dust as well as sand, and even vibrations and impacts during operation, being also able to withstand humidity, salt spray, altitude, explosive atmosphere, solar radiation, thermal extremes, thermal impacts, freezing/defrosting and tactical change from the standby mode to the operation mode, enabling dangerous sites and being equipped, in addition to the appropriate touch screen, with a GPS, with WI-FI connection means, USB connection ports and near-field data transmission (NFC), connectors with Pogo plugs or similar by the lower and rear parts and, as well as a main battery and a secondary lithium battery.

The tablet is housed on an ergonomic support which includes two grips for its handling, one for each hand, as well as a joystick-type handle, which is detachable, in addition to including an ergonomic belt with adjustable straps to hang from the shoulders, which facilitates work compared to the traditional hand-held camera, heavier and which causes tiredness in the operators, allowing him to release the camera without having to continually grip it.

The infrared camera is thus integrated with the tablet, mechanically, electrically as well as with respect to the data obtained by it.

The device shall incorporate a real-time programming software for the operation and office analysis of results with the corresponding user interface on the touch screen, offering broad connectivity with third parties, allowing to optimize detection of the corresponding leak, determining the processing frequency, processing transparency, the level of contrast of the processed image, in addition to being complemented with the recording of the images and fusing the visible image with the thermal or gas image, weighting the relationship of fusion between both images.

Said software shall include thermal image acquisition tools and tools for analysing said image, in accordance with acquisition and linear profile parameters for representation in a graph of the corresponding images, also including post-processing tools of the thermal image for the office display of the saved image.

The interface associated to the software shall also include control buttons of the display, play speed, gas image refresh time as well as adjustment of the overall image contrast, with visibility profiles and adjustments through the appropriate analysis with export of the video image.

Additionally, quantification software has been provided which incorporates a quantification algorithm of the gas cloud based on image treatment and recognition techniques, density of infrared absorption and in reference texts corresponding to gas cloud modelling, quantification algorithm and correlation factors.

The device allows executing auxiliary applications, as well as automatic report generation, both in series and as a specific request of each client, and the possibility of georeferencing and that said georeferencing is accessible via standard applications.

Said software shall also allow identification of the leak points on plans of the installation in several formats.

For its part, the infrared camera is based on infrared technologically spectrally optimized for hydrocarbon detection, which defines an infrared sensor, complemented with the corresponding lens that, with basic electronics of components for the connectivity and transmission of the electrical signal in image processed by SW, are housed in a casing, all without the need for cooling systems or moving parts.

Said lens shall comprise an exchangeable lens kit, with the camera being calibrated for the different lenses it is supplied with.

The device shall have various calibration ranges in temperature as well as a low signal-sound ratio.

For its part, the infrared sensor shall be of Tecless-LWIR-type, which allows drastically reducing costs with the same features that other systems or equipment on the market use for the same purpose, with a reduced size, low weight and optimum features.

We should also state that as the infrared camera is detachable this facilitates its maintenance, making it possible to use the camera in less accessible places, as it can be detached from the tablet and connected using an extension cable.

The device allows integrating tablets approved by the client without the need to change camera or software.

Likewise, as the tablet is the support of the software and the interface with the operator (HMI) it allows total flexibility for adding applications, and that the tablet can be dedicated to other functions.

For its part, the tablet environment is much more familiar and friendly, facilitating access to the menus as it is touch screen.

In terms of the ruggedized aspect of the solution, this facilitates its industrial use and use in poor climatological and environmental conditions, and enables its use with work gloves. Use for classified area of the unit pending.

The use of the tablet opens and facilitates its connectivity with third parties, being provided with universal interfaces (USB 3.0, WiFI, mobile connectivity, HDMI, . . . ). It allows the online transmission of images or videos.

With the treatment of thermal image and IR absorption, the quantification algorithm incorporated makes it possible to determine the gas escape rate.

From this structuring, the weight of the system obtained has an improvement in quantified portability of more than half a kilogram lighter with respect to commercial options on the market.

### DESCRIPTION OF THE DRAWINGS

To complement the description being made and in order to aid towards a better understanding of the characteristics of the invention, in accordance with a preferred example of practical embodiment thereof, a set of drawings is attached as an integral part of said description wherein, with illustrative and non-limiting character, the following has been represented:

FIG. 1.—Shows a perspective view of a gas detection device made in accordance with the object of the present invention.

FIGS. 2, 3, 4, 5 and 6.—Show different profile, front elevational, top plan, bottom plan and rear elevational views of the device of the previous figure, with its control or joystick detached.

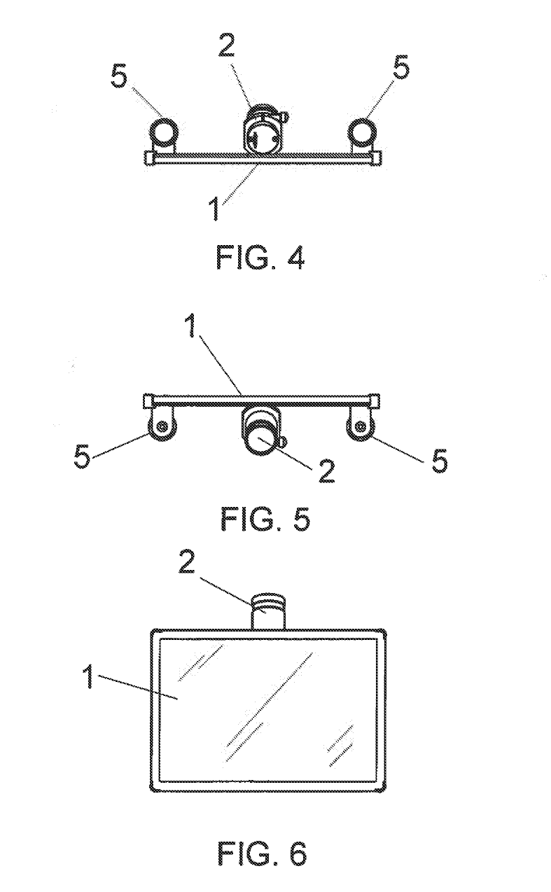

FIG. 7.—Finally shows an exploded view of the infrared camera that participates in the device of the invention.

### PREFERRED EMBODIMENT OF THE INVENTION

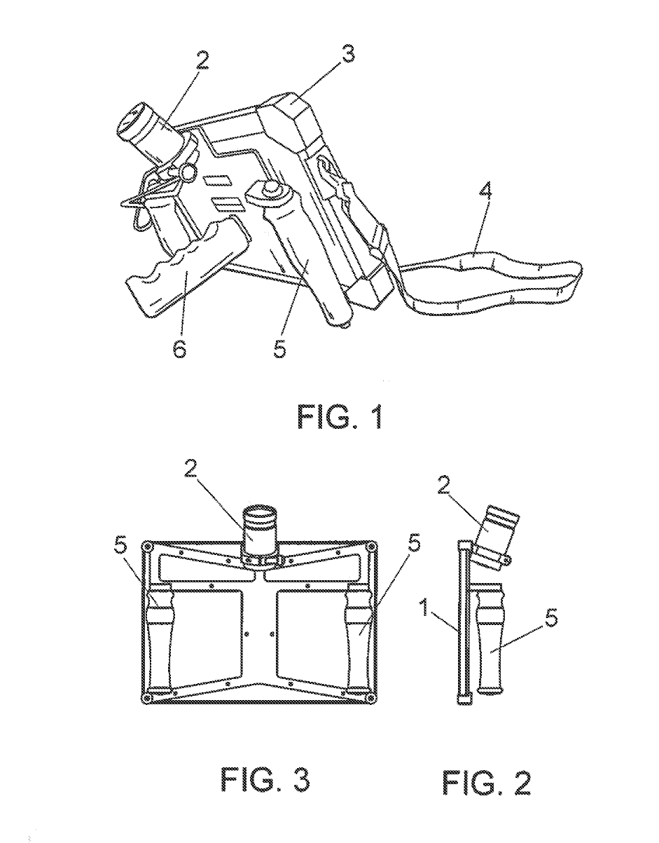

In light of the indicated figures, it can be observed how the device claimed is formed from a tablet (1) whereto an infrared camera (2) is associated via an ergonomic casing (3), with adaptable straps (4) to hang it on the shoulder, two side grips (5) disposed on the rear face of the casing (3) for handling by the operator, and a central handle (6) of joystick type with detachable character, and which is represented in FIG. 1.

The casing (3) gives the tablet (1) a ruggedized character, in order to protect it from dust, humidity, bumps, etc.

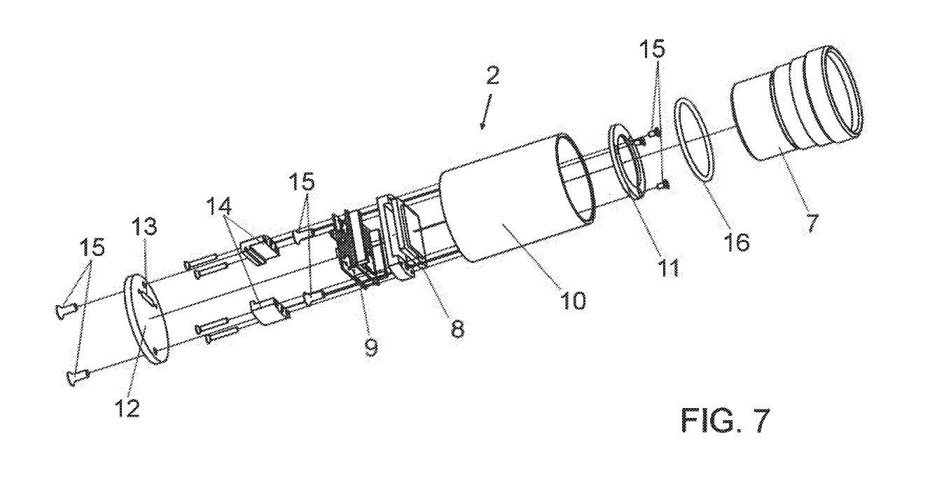

For its part, the infrared camera (2), shown exploded in FIG. 7, includes a lens (7), a detector spectrally optimized for hydrocarbon detection and which forms an infrared sensor (8), in combination with an electronic board (9), all housed in a casing (10) and fastened therein by means of a ring (11), fixing the unit to a lower cap (12) by means of screws (15) and separators (14), said lower cap having an opening or through-hole (13) for the connection cable that connects the camera to the tablet (1), establishing an airtight seal (16) between the lens (7) and the casing (10).

The characteristics and functions of the abovementioned components have been described in the previous section, such that the device can detect leaks of gas or other hydrocarbons and process them conveniently to achieve reliable data, processed and interpreted via the corresponding programming software associated to the tablet.

There only lastly remains to indicate that, as stated above, the infrared camera (2) can be detached from the casing (3), such that it can be used via an extension cable, in order to allow it to access places that are of difficult accessibility.

1. Device for gas detection and quantification, designed for the detection of leaks of natural gas and other hydrocarbons in gas phase, characterized in that it comprises a detachable infrared camera (3), with a detector (8) spectrally optimized for hydrocarbon detection, associated to an electronic board (9) of connectivity and transmission of the captured images to a tablet (1) ruggedized by means of a casing (3), provided with ergonomic gripping means, so that all these elements are integrated in a single portable unit.

2. Device for gas detection and quantification, according to claim 1, characterized in that the infrared sensor shall be of “Tecless-LWIR”-type.

3. Device for gas detection and quantification, according to claim 1, characterized in that the camera (2) has a casing (10) wherein the lens (7) has an exchangeable character, said casing including anchoring and fastening means of the detector to a rear cap (12) wherein the connector is established for the cable that connects the camera to the tablet.

4. Device for gas detection and quantification, according to claim 1, characterized in that the tablet (1) includes WI-FI communication means, GPS, USB ports, mobile connectivity and near-field communication means (NFC).

5. Device for gas detection and quantification, according to claim 1, characterized in that the tablet (1) includes dual battery, a main battery and a secondary battery.

6. Device for gas detection and quantification, according to claim 1, characterized in that the casing (3) includes a pair of side grips (5), a handle (6) of joystick-type, and an adjustable strap (4) for fastening the device to the shoulder.

7. Device for gas detection and quantification, according to claim 1, characterized in that it is provided with a kit of interchangeable lenses totally calibrated for the sensor and the electronics the unit is supplied with.

8. Device for gas detection and quantification, according to claim 1, characterized in that the detachable camera (3) can be connected to the tablet (1) via a cable with extender functions.
